(19) United States
(12) Patent Application Publication
(10) Pub. No.: US 2012/0045673 A1
(43) Pub. Date: Feb. 23, 2012

(54) Apparatus for Indicating Remaining Electric Charge of Battery and Device for Power Supplying and Recharging Comprising the Same

(75) Inventor: Seung-Jin Lee, Yongin-City (KR)

(73) Assignee: SAMSUNG MOBILE DISPLAY CO., LTD., Yongin-City (KR)

(21) Appl. No.: 13/184,934

(22) Filed: Jul. 18, 2011

(30) Foreign Application Priority Data
Aug. 23, 2010 (KR) 10-2010-0081492

(51) Int. Cl. H01M 10/48

(52) U.S. Cl. 429/92

(57) ABSTRACT

An apparatus for indicating remaining electric charge of a battery and a device for power supplying and recharging comprising the same are disclosed. The apparatus for indicating remaining electric charge of a battery according to an exemplary embodiment of the present invention comprises: a conducting part including a light emitting unit connected between one electrode connected to a positive electrode of the battery and another electrode connected to a negative electrode of the battery so as to emit light with luminance corresponding to a potential difference between the positive electrode and the negative electrode of the battery; and a nonconducting part preventing electric conduction by covering a remaining region other than parts of the battery to which the one electrode and the other electrode are connected.

### CLAIM OF PRIORITY

This application makes reference to, incorporates the same herein, and claims all benefits accruing under 35 U.S.C. §119 from an application earlier filed in the Korean Intellectual Property Office on Aug. 23, 2010, and there duly assigned Serial No. 10-2010-0081492.

### BACKGROUND OF THE INVENTION

1. Field of the Invention

The present invention relates to an apparatus for indicating remaining electric charge of a battery which indicates a charge state of a rechargeable battery, and a device for power supplying and recharging comprising the same, in order to control the charging and discharging of a rechargeable battery.

2. Description of the Related Art

With rapid development of network and IT technologies, diversified portable information processing apparatuses including a cellular phone, a notebook, a navigator, personal digital assistants (PDA), and the like have been developed.

The portable information processing apparatuses enable efficient work processing under diversified business environments and use rechargeable batteries which can be charged and supply power as a power supply with a tendency of pursuing the unifying of mobility and diversified functions.

The rechargeable batteries are diversified in specification and capacity depending on their usages, and a difference in a remaining level of remaining electric charge of the battery is increased as a using time of the portable information processing apparatus elapses.

Furthermore, if the voltage of the rechargeable battery is equal to or smaller than a predetermined voltage due to charging and discharging characteristics of the rechargeable battery, the battery is rapidly deteriorated, thereby remarkably reducing the life-span of the battery.

Accordingly, the current remaining electric charge of the rechargeable battery is accurately and conveniently known to a user so as to allow the user to prepare for the rapid discharging and deterioration of the rechargeable battery. For this purpose, an apparatus immediately and simply displaying the remaining electric charge of the rechargeable battery needs to be developed.

The above information disclosed in this Background section is only for enhancement of an understanding of the background of the invention, and therefore it may contain information which does not form the prior art already known in this country to a person of ordinary skill in the art.

### SUMMARY OF THE INVENTION

The present invention has been developed in an effort to provide an apparatus for indicating remaining electric charge of a battery so as to stably maintain and use the performance of the battery by conveniently and rapidly verifying the remaining electric charge of the battery by being attached to the rechargeable battery such as a lithium ion battery.

In addition, the present invention has been developed in an effort to provide an apparatus for indicating remaining electric charge of a battery which can allow a user to conveniently know the remaining electric charge of the battery by using a display device configured in a simple structure, the invention having production cost which is economical and providing high utilization of batteries depending on diversified capacities and performances.

Furthermore, the present invention has been developed in an effort to provide a device for power supplying and charging which can previously prevent deterioration, caused due to the discharging of a battery, by attaching a display device capable of immediately verifying a charged amount of the battery in real time, and which can be stably used for a very long life-span.

The technical problems solved by the present invention are not limited to the foregoing technical problems. Other technical problems, which are not described, can clearly be understood by those skilled in the art from the following description of the present invention.

An exemplary embodiment of the present invention provides an apparatus for indicating remaining electric charge of a battery, the apparatus comprising: a conducting part including a light emitting unit connected between one electrode connected to a positive electrode of the battery and another electrode connected to a negative electrode of the battery so as to emit light with luminance corresponding to a potential difference between the positive electrode and the negative electrode of the battery; and a nonconducting part preventing electric conduction by covering a remaining region other than parts of the battery to which the one electrode and the other electrode are connected.

The conducting part may further include a contact switch which is electrically connected to the one electrode or the other electrode so as to control an emission operation of the light emitting unit.

The contact switch may electrically connect or interrupt the battery and the light emitting unit and, when contacts are mechanically connected to each other, electrical conduction may be made from the battery to the light emitting unit. Accordingly, the mechanical contact switch may be made of an electrically conductive material. According to the exemplary embodiment, the contact switch may be configured in a part of one electrode or the other electrode which extends from the light emitting unit.

The light emitting unit may further include a transparent electrode layer or a conductive transparent film layer in a region where the light emitted from the light emitting unit is displayed to the outside.

The one electrode or the other electrode may be formed by the transparent electrode layer or the conductive transparent film layer.

Furthermore, the transparent electrode layer or the conductive transparent film layer may be included in a region of the one electrode or the other electrode which is connected to the light emitting unit.

The region displayed to the outside may be formed by a transparent material layer so as to allow a user to visually recognize the light emitted from the light emitting unit.

In the case of the light emitting unit which is integrally connected to the one electrode or the other electrode, one electrode or the other electrode corresponding to the external display region may be formed by the transparent material layer, or the one electrode or the other electrode itself may be made of a conductive transparent material.

The transparent electrode layer or the conductive transparent film layer may have light transmittance of 80% or higher in a visible light region.

The transparent electrode layer may be made of any one material selected from a group consisting of indium tin oxide (ITO), tin oxide (SnO₂), zinc oxide (ZnO), aluminum zinc oxide (AZO), gallium zinc oxide (GZO), indium zinc oxide (IZO), and carbon nano tube (CNT). However, the example of some exemplary embodiments is not necessarily limited to the material, and the conductive transparent material will be enough.

Meanwhile, the conductive transparent film layer may be a plated transparent polymer film. That is, a transparent film in the polymer plastic film is plated with conductive metal ions, and the plated transparent film may be provided on the external display region of the light emitting unit.

The light emitting unit may be formed by an energy conversion layer which may receive electric energy and convert the received electric energy into light energy. The energy conversion layer configuring the light emitting unit is not particularly limited, but may be an organic light emitting diode (OLED) as an organic emission layer.

In this case, a driving current of the light emitting unit may be in the range of a current amount corresponding to an open circuit voltage (OCV) of the battery when the state of charge (SOC) of the battery is the minimum to a current amount corresponding to the OCV of the battery when the SOC of the battery is the maximum.

Alternately, a current amount which flows on the light emitting unit at a voltage equal to or lower than the OCV of the battery when the SOC of the battery is the minimum may be 0. In other words, at a voltage which is equal to or lower than the OCV of the rechargeable battery when the SOC of the rechargeable battery is 0% which is the minimum, a resistance is unlimited, such that no current flows.

Another exemplary embodiment of the present invention provides a device for power supplying and charging which comprises: a plurality of rechargeable batteries; and a housing accommodating the plurality of rechargeable batteries; wherein each of the plurality of rechargeable batteries includes a remaining battery charge indicating section including a light emitting unit connected between one electrode connected to a positive electrode of the rechargeable battery and the other electrode connected to a negative electrode of the rechargeable battery so as to emit light with a luminance corresponding a potential difference of the rechargeable battery.

The remaining battery charge indicating section may further include a contact switch electrically connected to the one electrode and the other electrode so as to control an emission operation of the light emitting unit.

The contact switch may be a mechanical contact switch which electrically connects or interrupts the rechargeable battery and the light emitting unit.

A part of the housing, corresponding to a region where the light emitted from the light emitting unit of the remaining battery charge indicating section is displayed to the outside, is transparent so as to determine the remaining electric charge through the brightness of light emitted from the outside.

The remaining battery charge indicating section may further include a nonconducting part preventing electric conduction by covering the remaining region, other than parts of the battery to which the one electrode and the other electrode are connected.

The remaining battery charge indicating section of the remaining region, other than the region where the light emitted from the light emitting unit is displayed to the outside, may be included in the housing. That is, a predetermined region of the housing is opened to the outside to recognize the brightness of the light emitted from the light emitting unit of the remaining battery charge indicating section through the opened region. A user may easily verify the charged amount of the rechargeable battery through the opened region externally in the device for power supplying and charging.

The light emitting may further include a transparent electrode layer or a conductive transparent film layer in a region where the light emitted from the light emitting unit is displayed to the outside, or the one electrode or the other electrode may be formed by the transparent electrode layer or the conductive transparent film layer.

The transparent electrode layer or the conductive transparent film layer may have a light transmittance of 80% or higher in a visible light region.

The light emitting unit may be an organic light emitting diode (OLED), and a driving current of the light emitting unit may be in the range of a current amount corresponding to an open circuit voltage (OCV) of the battery when the state of charge (SOC) of the battery is the minimum to a current amount corresponding to the OCV of the battery when the SOC of the battery is the maximum. No driving current may be applied at a voltage equal to or lower than the OCV of the battery when the SOC of the battery is out of range.

According to the exemplary embodiment of the present invention, it is possible to provide an apparatus for indicating remaining electric charge which can conveniently and rapidly verify the remaining electric charge of a battery by being attached to a rechargeable battery, such as a lithium ion battery, and which can be used while stably maintaining the performance of the battery.

According to the exemplary embodiment of the present invention, it is possible to provide an apparatus for indicating remaining electric charge of a battery which is economical because production cost is saved by a simple structure in which a remaining electric charge indicating unit and a remaining electric charge measuring unit of the battery are unified with each other and can be utilized for batteries depending on various capacities and performances.

Furthermore, the device for power supply and charging according to an exemplary embodiment of the present invention is provided with an indicating apparatus which allows a user to immediately verify the charged amount of the battery in real time so as to prevent deterioration caused due to the discharging of the battery in advance, and which can be stably used for a very long life-span.

A remaining charged amount of each battery cell can be measured by a battery pack constituted by a plurality of battery cells and, as a result, battery cells having deteriorated performance can be easily determined and independently managed and handled.

Meanwhile, in the case in which the indicating apparatus is used for a battery pack, since energy can be discharged by allowing a light emitting unit to emit light in order to ensure that the constituent battery cells have the same charging rate, cell balancing in the battery pack can be easily performed.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings, in which like reference symbols indicate the same or similar components, wherein:

FIG. 1 is a configuration diagram showing a schematic model of a general rechargeable battery.

FIG. 2 is a graph showing the relationship between the SOC of a general rechargeable battery and the OCV of the rechargeable battery.

FIG. 3 is a graph showing the relationship between the SOC and the OCV of the battery showing a problem depending on a method of calculating the SOC of the rechargeable battery in the related art.

FIG. 4 is a configuration diagram showing a rechargeable battery attached to an apparatus for indicating remaining electric charge of a battery according to an exemplary embodiment of the present invention.

FIGS. 5 and 6 are diagrams showing an apparatus for indicating remaining electric charge of a battery according to an exemplary embodiment of the present invention.

FIGS. 7 and 8 are internal circuit diagrams of the rechargeable battery using the apparatus for indicating remaining electric charge of a battery shown in FIGS. 5 and 6, respectively.

FIG. 9 is a current-voltage characteristic curve of an organic light emitting diode of the apparatus for indicating remaining electric charge of a battery according to an exemplary embodiment of the present invention.

FIG. 10 is a configuration diagram showing a plurality of rechargeable batteries attached to an apparatus for indicating remaining electric charge of a battery according to an exemplary embodiment of the present invention.

FIG. 11 is a graph showing measurement data of an apparatus for indicating remaining electric charge of a battery according to an exemplary embodiment of the present invention as the relationship between the SOC and the OCV of the battery.

### DETAILED DESCRIPTION OF THE INVENTION

The present invention will be described more fully hereinafter with reference to the accompanying drawings, in which exemplary embodiments of the invention are shown. As those skilled in the art will realize, the described embodiments may be modified in various different ways, all without departing from the spirit or scope of the present invention.

Furthermore, in the exemplary embodiments, like reference numerals designate like elements throughout the specification representatively in a first exemplary embodiment, and only elements other than those of the first exemplary embodiment will be described.

The drawings and description are to be regarded as illustrative in nature and not restrictive. Like reference numerals designate like elements throughout the specification.

In the specification and the claims that follow, when it is described that an element is “coupled” to another element, the element may be “directly coupled” to the other element or “electrically coupled” to the other element through a third element. In addition, unless explicitly described to the contrary, the word “comprise” and variations such as “comprises” or “comprising” will be understood to imply the inclusion of stated elements but not the exclusion of any other elements.

In the description of the present invention, a device for power supplying and charging may be a concept meaning a rechargeable battery which can supply (discharge) and recharge electric energy.

In the description of the present invention, remaining electric charge, charge rate, or state of charge (SOC) are indices indicating remaining electric charge when the current electric charge of the device for power supplying and charging is compared to a full charging amount as a percentage. In general, a charging rate of 100% means that the battery is in a full charging state and a charging rate of 0% means that the battery is a full discharging state.

Furthermore, in the description of the present invention, an open circuit voltage (OCV) represents an electric potential difference between both terminals in a state in which no load is connected to a rechargeable battery, that is, a circuit is opened. In other words, the OCV represents a potential difference between both terminals measured under a condition in which external current does not flow between both terminals even though current may flow due to self-discharging in the rechargeable battery.

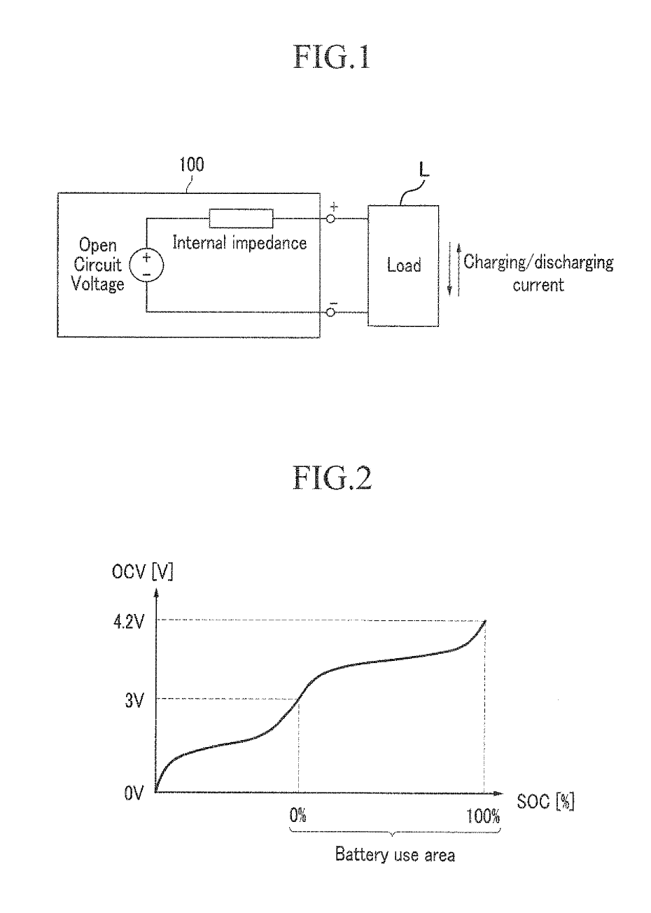

FIG. 1 is a configuration diagram showing a schematic model of a general rechargeable battery.

As known, in the schematic model of the rechargeable battery shown in FIG. 1, a predetermined external load L is applied between a positive electrode and a negative electrode of the rechargeable battery 100 having a predetermined internal impedance so as to charge or discharge the rechargeable battery 100. In this case, the open circuit voltage (OCV) which is applied between the positive electrode and the negative electrode of the rechargeable battery 100 has a one-to-one primary functional relationship with the state of charge (SOC) of the corresponding rechargeable battery 100.

In general, hereinafter, a lithium ion battery will be described as an example. When the OCV of the lithium ion battery is 3V, the SOC of the battery may be defined as 0% and, when the OCV is 4.2V, the SOC may be defined as 100%. When the OCV of the lithium ion battery is equal to or lower than 3V, the life-span of the battery is rapidly deteriorated. Therefore, when the OCV decreases to 3V or lower, the battery should not be discharged.

FIG. 2 is a graph showing the relationship between the SOC of a general rechargeable battery and the OCV of the rechargeable battery.

As known, with reference to the graph of FIG. 2, the state of charge (SOC) of the rechargeable battery and the open circuit voltage (OCV) of the rechargeable battery have substantially a primary functional relationship therebetween. That is, the SOC and the OCV of the rechargeable battery correspond to each other on a one-to-one basis in a use area and, as the OCV of the battery increases, the SOC of the rechargeable battery corresponding thereto increases. When a charged current amount supplied to the battery increases, a potential difference between both terminals of the battery increases. Therefore, the OCV of the battery increases. The graph of FIG. 2 shows an SOC-OCV characteristic curve of the lithium ion rechargeable battery. Referring to this graph, the SOC in the range of 0 to 100% corresponds to the OCV of the lithium ion battery in the range of 3 to 4.2V. However, although the rechargeable battery is not necessarily limited to the battery shown in FIG. 2, the OCV of the corresponding rechargeable battery increases depending on a charging state of the battery which is in proportion to the current amount charged in the rechargeable battery.

In the related art, a voltage measurement method and a current measurement method are generally used in order to measure the SOC of the rechargeable battery.

In the method of measuring the SOC of the battery by measuring the voltage, the OCV is calculated by measuring the voltages of both terminals of the battery in a state in which no external load is applied, and the current SOC of the battery is deduced from the measured OCV by using the SOC-OCV table depending on the battery.

Meanwhile, in the method of calculating the SOC of the battery by measuring the current, when an initial value of the SOC of the battery is known, the external load is applied to the battery and charging/discharging current that flows in the corresponding battery is periodically measured and accumulated to calculate the current SOC of the battery.

In this case, an equation for calculating the SOC of the battery is expressed as Equation 1 below.

$${SOC}_{t} = {SOC}_{t 0} - \frac{{\int }_{t 0}^{t} i ( t ) d t}{BatteryCapacity} [ \% ] \qquad ( 1 )$$

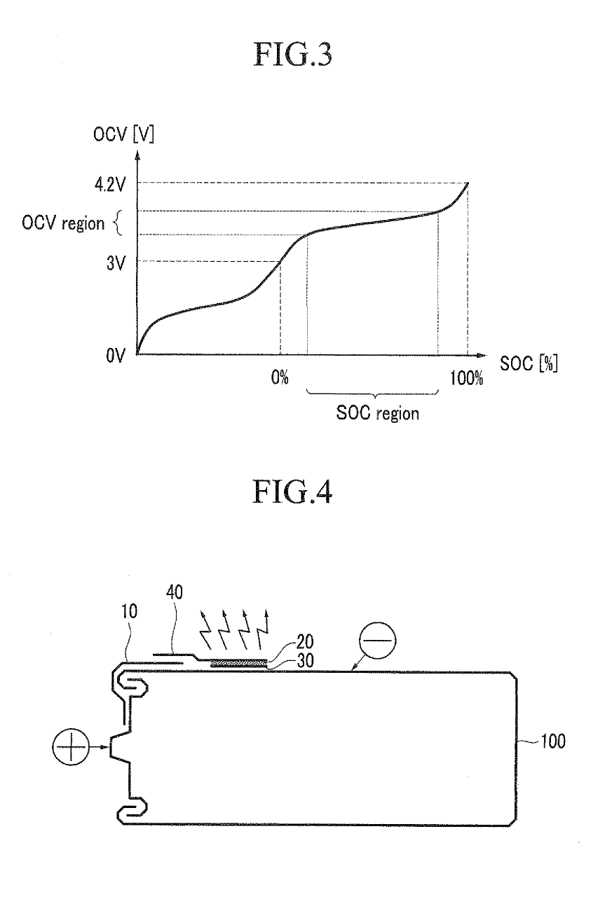

FIG. 3 is a graph showing the relationship between the SOC and the OCV of the battery showing a problem depending on a method of calculating the SOC of the rechargeable battery in the related art.

The method of calculating the SOC of the battery through Equation (1) has problems. The voltage measurement method has a problem in that accuracy is low because an SOC error of the battery, corresponding to even a minute error of the OCV calculated through the voltages of both terminals of the battery, is very large. That is, as known from the graph of FIG. 3, the range of the OCV corresponding to the range of the SOC of 0 to 100% where the battery is primarily used in the SOC-OCV characteristic curve of the lithium ion battery is very small. Accordingly, even though a minute voltage difference is generated at the time of measuring the OCV, an error width of the SOC of the battery corresponding thereto is remarkably large. As a result, it is impossible to accurately determine a current state of the battery.

Meanwhile, the current measurement method has a limitation in that the initial value of the SOC of the rechargeable battery should be known and, for this, a complicated process of calculating an initial battery SOC by measuring an initial OCV while using the battery has to be performed.

Therefore, the current measurement method is inconvenient as a procedure in that a preliminary process should be performed. In addition, the method has disadvantages in that a remaining battery charge measuring apparatus is complicated and the manufacturing cost is increased because both a voltage measurement device and a current measurement device have to be provided.

Furthermore, a circuit element for measuring the SOC of the battery and a display unit are separately provided in the apparatus for indicating the SOC of the battery in the related art, which has a complicated structure. Therefore, it is not suitable for a user to immediately verify the remaining charged amount of the battery in real time.

In addition, in the case of a battery pack configured by connecting a plurality of batteries in series or in parallel, a performance deviation occurs for each battery cell, and the deviation has a large influence on the overall performance of the battery pack. Therefore, in the battery pack, a cell having deteriorated performance should be replaced by frequently measuring the remaining electric charge of the battery for each cell.

When the remaining battery charge measuring apparatus is mounted for each battery cell, the system is complicated and the manufacturing cost is increased. Therefore, in a general application such as a battery pack of a notebook PC, the remaining SOC of the battery is measured by measuring only the output voltage of the entire battery pack. In this case, when the performances of a small number of batteries are deteriorated in the battery pack, it is difficult to detect the deteriorated performances.

Accordingly, the present invention provides an apparatus for indicating the remaining electric charge which is economical due to its simple structure and low manufacturing cost while solving all of the problems experienced by the remaining battery SOC measuring apparatus of the related art.

FIG. 4 is a configuration diagram showing a rechargeable battery attached to an apparatus for indicating remaining electric charge of a battery according to an exemplary embodiment of the present invention.

As shown in FIG. 4, the apparatus for indicating remaining electric charge of a battery according to the exemplary embodiment of the present invention is constituted by the rest components other than the rechargeable battery 100.

That is, the apparatus for indicating remaining electric charge of a battery according to the exemplary embodiment of the present invention is constituted by one electrode connected to a positive (+) electrode of the rechargeable battery 100, another electrode connected to a negative (−) electrode of the rechargeable battery 100, and a light emitting unit which is connected between the one electrode and the other electrode, and which emits light with luminance corresponding to a potential difference between the positive electrode and the negative electrode of the battery. Furthermore, although not shown in FIG. 4, the remaining regions, other than the portions where the one electrode and the other electrode are connected to both electrodes of the battery, are formed by a nonconducting part which is not electrically conducted.

The nonconducting part may be formed by a polymer plastic film having excellent formability. The nonconducting part protects the apparatus for indicating remaining electric charge of a battery from the external environment and interrupts electrical connection.

The one electrode, the other electrode, and the light emitting unit of the apparatus for indicating remaining electric charge of a battery according to the exemplary embodiment of the present invention may be referred to as a conducting part so as to correspond to the nonconducting part.

The one electrode may be an anode electrode 10 connected to the positive electrode of the rechargeable battery and the other electrode may be a cathode electrode 30 connected to the negative electrode of the rechargeable battery.

Furthermore, the light emitting unit may be an organic light emitting diode 20 formed by an organic emission layer.

In the exemplary embodiment of FIG. 4, the conducting part of the apparatus for indicating remaining electric charge of a battery further includes a contact switch 40 which is formed in the anode electrode 10 and which controls an emission operation of the organic light emitting diode 20. The formation of the contact switch 40 is not essential, but it is preferably installed when a user determines the remaining electric charge of the battery by selectively operating the contact switch 40 at a desired time in person, or the contact switch 40 is applied to an application in which the self-discharging of the battery needs to be prevented through the apparatus for indicating remaining electric charge of the battery.

The contact switch 40 may be made of a conductive material so as to control the emission operation of the organic light emitting diode 20, and may be a mechanical contact switch.

The contact switch 40 is exposed to the outside of the rechargeable battery so as to be directly operated by the user, or it may be operated by using an intermediate medium.

Herein, the intermediate medium as an additional device for controlling the mechanical contact of the switch may be a device which manually or automatically opens and closes the mechanical contact switch 40.

In the apparatus for indicating remaining electric charge of a battery according to the exemplary embodiment of FIG. 4, the rest region other than a region where the organic light emitting diode 20 displaying the remaining electric charge by emitting light to the outside, the anode electrode 20, and the cathode electrode 30 may be hidden in a packing film of the battery. That is, when the rechargeable battery attached to the apparatus for indicating remaining electric charge of a battery is apparently viewed, all the rest parts other than only the light emitting unit may be included in a packing film of a nonconductor.

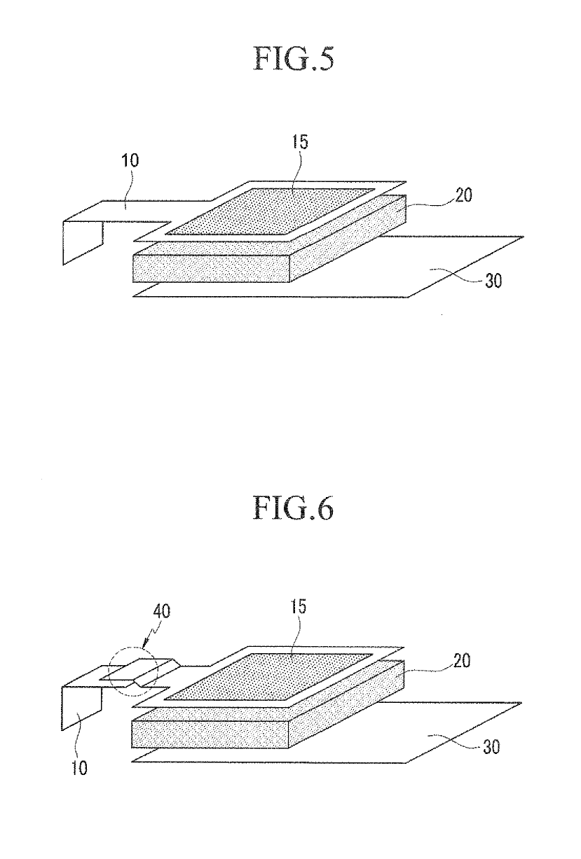

Diagrams schematically showing only the apparatus for indicating remaining electric charge of a battery according to the exemplary embodiment of the present invention in the configuration diagrams of the battery and the apparatus for indicating remaining electric charge of a battery of FIG. 4 are shown in FIGS. 5 and 6.

FIG. 5 is a configuration diagram of an apparatus for indicating remaining electric charge of a battery that does not include the mechanical contact switch 40, and FIG. 6 is a configuration diagram of an apparatus for indicating remaining electric charge of a battery that includes the mechanical contact switch 40. Since the mechanical contact switch 40 has been already described, a detailed description thereof will be omitted.

The anode electrode 10 and the cathode electrode 30 of the apparatus for indicating remaining electric charge of a battery are attached onto the top and bottom surfaces, respectively, of the organic light emitting diode 20 so as to transfer current which flows out to the organic light emitting diode 20 through both electrodes of the rechargeable battery.

In this case, the current drives the organic light emitting diode 20 so as to generate light with luminance corresponding to the corresponding current, and the light is emitted to the outside so as to allow the user to know the current remaining electric charge of the battery. If the light is not emitted through the organic light emitting diode 20, the corresponding battery is maximally discharged. Accordingly, the battery may be recharged and used.

The anode electrode 10 and the cathode electrode 30 of the apparatus for indicating remaining electric charge of a battery may be made of a conductive material, and may be formed by conductive metal or a conductive polymer film.

Referring to FIGS. 5 and 6, a region where the light emitted from the organic light emitting diode 20 driven with a current amount corresponding to the remaining electric charge of the rechargeable battery is displayed to the outside is provided on the top surface of the organic light emitting diode 20.

The region may be a transparent window 15 additionally configured in a predetermined region of the organic light emitting diode 20.

The transparent window 15 may be a transparent electrode layer or a conductive transparent film layer, but is not necessarily limited thereto, and is preferably formed by a material layer having light transmittance of 80% or higher in a visible light region.

If the transparent window 15 is additionally formed in a light emitting region outside of the organic light emitting diode 20, the anode electrode 10 is connected to the rest region where the transparent window 15 is positioned so as to allow the current to flow out to the organic light emitting diode 20.

However, as another example, the anode electrode 10 connected to the organic light emitting diode 20 may be formed by a transparent electrode layer or a conductive transparent film layer.

When the anode electrode 10 or the cathode electrode 30 is formed by the transparent electrode layer or the conductive transparent film layer, the anode electrode 10 or the cathode electrode 30 may be bent due to the flexibility of the material so as to be closely attached onto the outer surface of the rechargeable battery.

The material configuring the transparent electrode layer or the conductive transparent film layer is not particularly limited.

The transparent electrode layer may be made of materials such as indium tin oxide (ITO), tin oxide (SnO₂), zinc oxide (ZnO), aluminum zinc oxide (AZO), gallium zinc oxide (GZO), indium zinc oxide (IZO), and carbon nano tube (CNT).

Meanwhile, the conductive transparent film layer may be electrically conducted by plating a transparent polymer plastic film with metal ions.

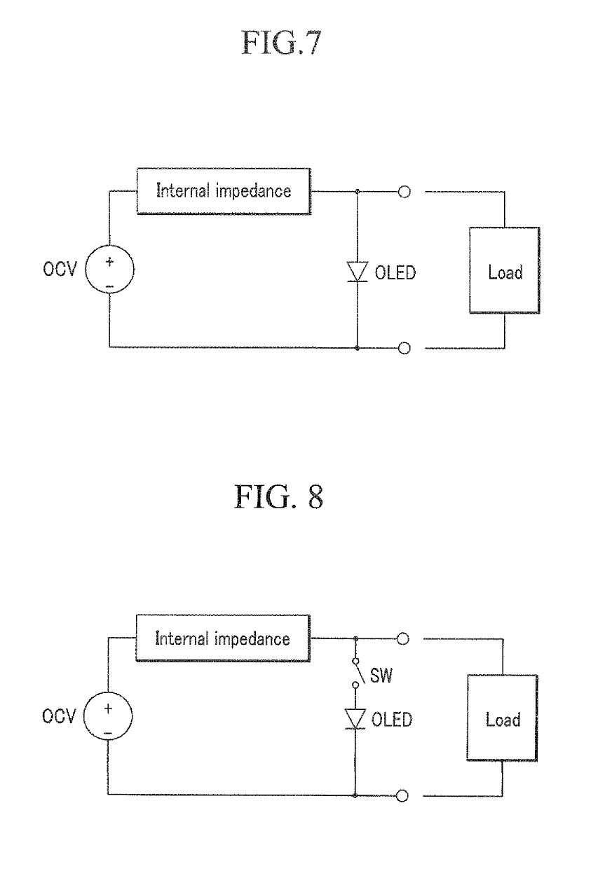

FIGS. 7 and 8 are internal circuit diagrams of the rechargeable battery using the apparatus for indicating remaining electric charge of a battery shown in FIGS. 5 and 6, respectively.

Since the apparatus for indicating remaining electric charge of a battery shown in FIG. 6 further includes the contact switch 40 which is connected to the anode electrode 10 so as to control electrical connection, the corresponding contact switch 40 is merely further shown in FIG. 8 as switch SW, and FIG. 8 otherwise has no significant difference from FIG. 7.

That is, the circuit diagrams of FIGS. 7 and 8 show a circuit diagram in which the organic light emitting diode 20 is connected between the positive electrode and the negative electrode of the rechargeable battery.

When the self-discharging of the rechargeable battery needs to be prevented, it is possible to control the operation of the organic light emitting diode 20 by mounting the contact switch SW as shown in FIG. 8.

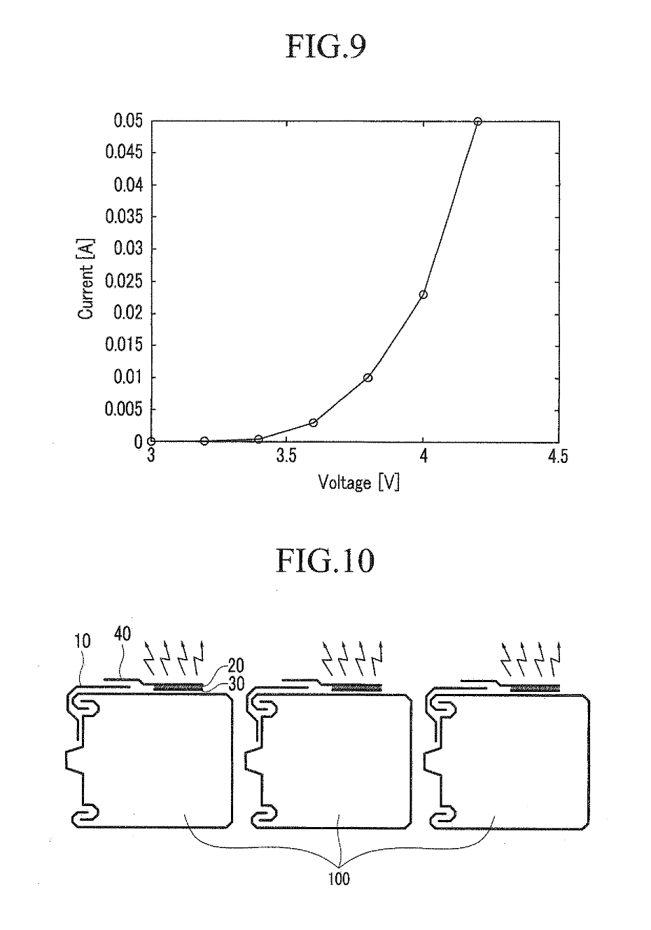

As the exemplary embodiment, in the apparatus for indicating remaining electric charge of a battery according to the exemplary embodiment of the present invention attached to a lithium ion rechargeable battery among the rechargeable batteries of which SOC will be measured, a current-voltage characteristic curve of the organic light emitting diode 20 is shown in FIG. 9.

As already described, referring to the variation function of the SOC corresponding to the OCV of the lithium ion rechargeable battery, the OCV of the lithium ion rechargeable battery is approximately 3V when the SOC is the minimum 0%, that is, in the full discharging state, and the OCV is approximately 4.2V when the SOC is the maximum (100%), that is, in the full charging state. Therefore, a potential difference between both electrodes of the battery is generated between 3 V and 4.2V. A current amount corresponding thereto is shown in a graph of FIG. 9.

Accordingly, a driving current of the organic light emitting diode 20 which is connected to both electrodes of the lithium ion rechargeable battery, and which emits light with the current amount depending on the corresponding potential difference, is included in the range of the current amount shown in FIG. 9. That is, with respect to an element characteristic of the organic light emitting diode 20, when the potential difference between both electrodes of the lithium ion rechargeable battery is equal to or lower than 3V, a resistance is unlimited such that no current flows.

In the apparatus for indicating remaining electric charge of the lithium ion rechargeable battery according to the exemplary embodiment of the present invention, the driving current of the organic light emitting diode 20 may be in the range of 0 to 0.05 A. The potential difference applied between both electrodes of the lithium ion rechargeable battery corresponds to the current SOC of the battery and, when the organic light emitting diode 20 is driven to emit light with the current amount depending on the corresponding potential difference, the SOC of the lithium ion rechargeable battery may be known by the luminance of the light.

A graph in which the OCV of the battery and the SOC of the battery corresponding thereto are experimentally acquired on the basis of the luminance of the light emitted from the organic light emitting diode 20 by using the apparatus for indicating remaining electric charge of the battery which is attached to the lithium ion rechargeable battery according to the exemplary embodiment of the present invention is shown in FIG. 11.

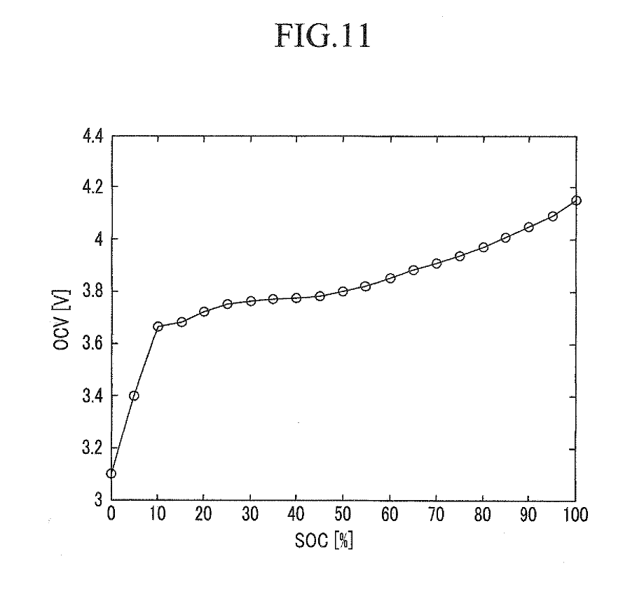

FIG. 10 is a configuration diagram showing a plurality of rechargeable batteries attached to an apparatus for indicating remaining electric charge of a battery according to an exemplary embodiment of the present invention.

FIG. 10 shows an example in which the apparatus for indicating remaining electric charge of a battery attached to one battery, as shown in FIG. 4, is applied to a battery packet including a plurality of battery cells.

Since the apparatus for indicating remaining electric charge of a battery attached to each battery cell is the same as the above-mentioned apparatus, a description thereof will be omitted.

The apparatus for indicating remaining electric charge of the battery, which is used for each of the plurality of battery cells constituting the battery pack, preferably includes the contact switch 40 in order to adjust balancing in charging states of the battery cells.

The organic light emitting diode 20 of the apparatus for indicating remaining electric charge attached to each of the plurality of battery cells constituting the battery pack emits light with luminance corresponding to a charged amount of the corresponding battery cell. Therefore, if there is a problem in the performance of a predetermined battery cell, the corresponding problem may be determined on the basis of the luminance of the emitted light. As a result, it is possible to adjust the remaining electric charge of the battery cell having the deteriorated performance to be similar or the same as other battery cells.

Meanwhile, the battery cells constituting the battery pack preferably have the same SOC for the overall performance of the battery pack. For this, it is possible to induce the discharging of the corresponding battery cell by artificially turning on a contact switch 40 of a battery cell, the SOC of which is exceeded. When the contact switch 40 is turned on, the corresponding battery cell is self-discharged through the organic light emitting diode 20 of the apparatus for indicating remaining electric charge of a battery, which is mounted thereon. As a result, it is possible to easily perform cell balancing in the battery pack.

While this invention has been described in connection with what is presently considered to be practical exemplary embodiments, it is to be understood that the invention is not limited to the disclosed embodiments. On the contrary, this invention is intended to cover various modifications and equivalent arrangements included within the spirit and scope of the appended claims. Furthermore, the materials of the components described in the specification may be selectively substituted with various known materials by those skilled in the art. In addition, some of the components described in the specification may be omitted without deterioration of the performance, or may be added in order to improve performance, by those skilled in the art. Moreover, the sequence of the steps of the method described in the specification may be changed depending on the process environment or equipment by those skilled in the art. Accordingly, the scope of the present invention should be determined not by the above-mentioned exemplary embodiments, but by the appended claims and equivalents thereof.

What is claimed is:

1. An apparatus for indicating remaining electric charge of a battery, comprising:
a conducting part comprising a light emitting unit connected between one electrode connected to a positive electrode of the battery and another electrode connected to a negative electrode of the battery so as to emit light with luminance corresponding to a potential difference between the positive electrode and the negative electrode of the battery; and
a nonconducting part for preventing electric conduction by covering a remaining region other than parts of the battery to which the one electrode and the other electrode are connected.

2. The apparatus of claim 1, wherein the conducting part further comprises a contact switch electrically connected to one of said one electrode and said another electrode so as to control an emission operation of the light emitting unit.

3. The apparatus of claim 2, wherein the contact switch selectively electrically connects and interrupts the battery and the light emitting unit.

4. The apparatus of claim 1, wherein the light emitting unit further comprises one of a transparent electrode layer and a conductive transparent film layer in a region where the light emitted from the light emitting unit is displayed to an outside.

5. The apparatus of claim 4, wherein one of said one electrode and said another electrode is formed by said one of the transparent electrode layer and the conductive transparent film layer.

6. The apparatus of claim 4, wherein one of said one electrode and said another electrode further comprises said one of the transparent electrode layer and the conductive transparent film layer in the region where the light emitted from the light emitting unit is displayed to the outside.

7. The apparatus of claim 4, wherein said one of the transparent electrode layer and the conductive transparent film layer has a light transmittance of at least 80% in a visible light region.

8. The apparatus of claim 7, wherein the transparent electrode layer is made of any one material selected from a group consisting of indium tin oxide (ITO), tin oxide (SnO₂), zinc oxide (ZnO), aluminum zinc oxide (AZO), gallium zinc oxide (GZO), indium zinc oxide (IZO), and carbon nano tube (CNT).

9. The apparatus of claim 4, wherein the conductive transparent film layer is a plated transparent polymer film.

10. The apparatus of claim 1, wherein the light emitting unit is an organic light emitting diode (OLED).

11. The apparatus of claim 1, wherein a driving current of the light emitting unit is in the range of a current amount corresponding to an open circuit voltage (OCV) of the battery when the state of charge (SOC) of the battery is a minimum to a current amount corresponding to the OCV of the battery when the SOC of the battery is a maximum.

12. The apparatus of claim 1, wherein a current amount, which flows in the light emitting unit at a voltage no greater than the OCV of the battery when the SOC of the battery is a minimum, is 0.

13. A device for power supplying and charging, comprising:
a plurality of rechargeable batteries; and
a housing accommodating the plurality of rechargeable batteries;
wherein each of the plurality of rechargeable batteries comprises a remaining battery charge indicating section comprising a light emitting unit connected between one electrode connected to a positive electrode of the rechargeable battery and another electrode connected to a negative electrode of the rechargeable battery so as to emit light with a luminance corresponding to a potential difference of the rechargeable battery.

14. The device of claim 13, wherein the remaining battery charge indicating section further comprises a contact switch electrically connected to said one electrode and said another electrode so as to control an emission operation of the light emitting unit.

15. The device of claim 14, wherein the contact switch selectively electrically connects and interrupts the rechargeable battery and the light emitting unit.

16. The device of claim 13, wherein a part of the housing, corresponding to a region where the light emitted from the light emitting unit of the remaining battery charge indicating section is displayed to an outside, is transparent.

17. The device of claim 13, wherein the remaining battery charge indicating section further comprises a nonconducting part for preventing electric conduction by covering a remaining region other than parts of a battery to which said one electrode and said another electrode are connected.

18. The device of claim 13, wherein the remaining battery charge indicating section of a remaining region, other than parts where the light emitted from the light emitting unit is displayed to the outside, is included in the housing.

19. The device of claim 13, wherein the light emitting unit further comprises one of a transparent electrode layer and a conductive transparent film layer in a region where the light emitted from the light emitting unit is displayed to an outside.

20. The device of claim 19, wherein one of said one electrode and said another electrode is formed by said one of the transparent electrode layer and the conductive transparent film layer.

21. The device of claim 19, wherein one of said one electrode and said another electrode comprises said one of the transparent electrode layer and the conductive transparent film layer in the region where the light emitted from the light emitting unit is displayed to the outside.

22. The device of claim 19, wherein said one of the transparent electrode layer and the conductive transparent film layer has light transmittance of at least 80% in a visible light region.

23. The device of claim 13, wherein the light emitting unit is an organic light emitting diode (OLED).

24. The device of claim 13, wherein a driving current of the light emitting unit is in a range of a current amount corresponding to an open circuit voltage (OCV) of a battery when the state of charge (SOC) of the battery is a minimum to a current amount corresponding to the OCV of the battery when the SOC of the battery is a maximum.

25. The device of claim 13, wherein a current amount, which flows in the light emitting unit at a voltage no greater than the OCV of the battery when the SOC of the battery is a minimum, is 0.
